(19) United States
(12) Patent Application Publication
(10) Pub. No.: US 2002/0094785 A1
(43) Pub. Date: Jul. 18, 2002

(54) Portable device used to measure passive intermodulation in radio frequency communication systems

(76) Inventor: Bradley W. Deats, Parker, CO (US)

Correspondence Address: SHERIDAN ROSS PC, 1560 BROADWAY, SUITE 1200, DENVER, CO, 80202

(21) Appl. No.: 09/955,768

(22) Filed: Sep. 18, 2001

Related U.S. Application Data
(63) Continuation-in-part of application No. 09/888,101, filed on Jun. 22, 2001.
(60) Provisional application No. 60/219,254, filed on Jul. 18, 2000.
(60) Provisional application No. 60/233,346, filed on Sep. 18, 2000.

(51) Int. Cl. H04B 17/00

(52) U.S. Cl. 455/67.3

(57) ABSTRACT

The present invention relates to a measurement method for characterizing passive intermodulation in radio frequency (RF) communication systems. The method is particularly well suited for characterizing the passive intermodulation level of fielded RF subsystems and components where AC line power may not be readily available. The method utilizes a minimum level of RF energy to perform the characterization, minimizing the disruption to nearby communication systems. By utilizing low average RF power levels, a device which utilizes this method can be designed for battery operation and hand-held use. This makes the device significantly less costly than currently available measurement solutions.

### CROSS REFERENCE TO RELATED APPLICATIONS

The present application is a continuation-in-part of U.S. patent application Ser. No. 09/888,101 filed Jun. 22, 2001 entitled “APPARATUS AND METHOD FOR MEASURING AND IDENTIFYING SOURCES OF COMMUNICATIONS INTERFERENCE”, further identified as attorney docket no. 4229-3. Priority is claimed from U.S. patent application Ser. No. 09/888,101, from U.S. Provisional Patent Application Serial No. 60/219,254 filed Jul. 18, 2000 entitled “Apparatus and Method for measuring and Identifying Sources of Communications Interference,” and further identified as attorney docket number 4229-3PROV, and from U.S. Provisional Patent Application Serial No. 60/233,346 filed Sep. 18, 2000 entitled “PORTABLE DEVICE USED TO MEASURE PASSIVE INTERMODULATION IN RF COMMUNICATION SYSTEMS” and further identified as attorney docket no. 4229-5PROV. The disclosures of all of the above-identified references are incorporated herein by reference in their entirety.

### FIELD OF THE INVENTION

The present invention relates generally to radio frequency communication systems and is particularly apt for use in wireless mobile communication applications. In particular, the present invention relates to the field testing of radio frequency communications systems.

### BACKGROUND OF THE INVENTION

Communications receivers are generally designed to detect and demodulate signal levels which are very low in power. Occasionally, these desired signals are present along with undesired signals. In the United States, the Federal Communications Commission (hereinafter “FCC”) carefully regulates the location, frequency, power level, and gain of radio frequency (hereinafter “RF”) transmitters to minimize the presence of these undesired signals (otherwise known as interference) in RF communication systems. However, despite these measures, malfunctioning transmitters, interactions of adjacent transmitters, and even the presence of decaying mechanical junctions (e.g. rain gutters) can cause interference, thus affecting the quality of reception of numerous devices which utilize RF signals, such as cell phones and other communications apparatus. Furthermore, as the density and bandwidth of radio transmitters increases, so does the potential for interference between the transmitters and their respective receivers. Based on the tremendous sums of money spent annually by industry to identify sources of communications interference, a great need exists for a cost efficient, effective method for identifying sources of communications interference.

FIG. 1 illustrates a simple communication system. Each party desires to transmit one or more channels of information across a common medium. The signals are typically modulated in some fashion 100, and then launched into the common medium 104 (examples of such a medium include free space and coaxial cable). This modulation and launching process typically produces not only the desired signals 108, but also signals at a much lower level which are not desired 112 and are not typically in the intended frequency/wavelength range. Further, while traveling through the medium, these signals can combine in a non-linear fashion to produce additional unwanted signals. Accordingly, unwanted signals that interfere with the desired signals are perceived upon demodulation at the receivers 116.

The presence of these unwanted, or interfering signals in a communication system can adversely impact the capacity of the communication system and/or the quality of the information passed across this communication system. For example, in a wireless RF data link, the effective bandwidth of the data link may be reduced by the presence of interference. In a second example, the quality of the spoken voice may become unintelligible using a wireless RF telephone with excessive interference levels. When such symptoms of interference appear, it is desirable to locate and mitigate the cause of the interference as quickly as possible.

Using current practice, the locating of the interference typically involves taking a signal receiver to the communications medium along with a directional probe to determine the source of the interfering energy. For example, RF communications interference is typically located by using an RF spectrum analyzer together with a directional antenna to determine the direction from which interfering signals are arriving.

Difficulties presented by currently known techniques include:

1) The interfering energy can be caused by an interaction of multiple transmitters. Although the primary source of the energy can be determined, the identity of the other contributing transmitter(s) is/are unknown;

2) The interfering energy is typically present with desired signals within the spectrum containing interference and differentiating between the two types of signals can be difficult;

3) The offending transmitters may not be generating interference on a continual basis. This requires tedious, continuous human monitoring of the spectrum until the interference occurs. This can be costly in terms of manpower and resources;

4) The source of the interfering signals is often traced to a group of transmitters. Isolating the specific transmitter or transmitters responsible for the interference often requires individually shutting down suspect transmitters until the interference is mitigated. This is undesirable as it interrupts communications on a nominally functional communications system; and

5) The source of the RF interference may be a metallic object which is re-radiating signals from nearby transmitters. Although the source of the interference is readily determined (i.e., the metallic object), the identity of the specific transmitters which are stimulating a response from this object is not readily determined.

One source of interference in an RF communication system is the generation of intermodulation products in RF filters, cable assemblies, antennas, and structures surrounding the transmitters and receivers. As these are all nominally passive devices, the resulting intermodulation (IM) signals are known as Passive Intermodulation (passive IM).

Current measurement techniques used to characterize passive IM utilize two or more RF carriers 200 which may be either static, or swept in frequency. As shown in FIG. 2 these carriers are amplified 204, combined 208, and injected into the device under test 212 at a first port 216 by a first duplexer (or diplexer) 220. A sensitive RF receiver 224 is placed behind a bandpass filter to allow the reception of the low-level IM signal without being saturated by the reflected high power RF signals used to stimulate the passive IM response.

A commonly used and commercially available system 300 for performing the technique illustrated in FIG. 2 is shown in FIG. 3. Although this type of system 300 can produce accurate and repeatable test results, it is difficult and undesirable to use in a field environment due to its weight, power consumption, and high cost.

During final integration and testing of an RF communications base station, it is common for one end on each of the RF cable assemblies to be installed in the field. Final connections to the base station equipment and external antennas are also performed by hand. Although many of the base station components are tested (or based on designs tested) by the passive IM analyzer of FIG. 3, the system performance is not verified following these critical field connections. Because a major cause of passive IM is poor mechanical contact, the field installed connections can be a major source of passive IM. Due to the inconvenience associated with the measurement of passive IM in the field, it often goes unmeasured.

The current measurement techniques for characterizing the passive IM in fielded systems requires the transmission of high-power RF tones (or carriers) through each transmit signal path and monitoring the IM power generated in the receive band of interest. This is undesirable for the following reasons:

1. Radiating high power tones can disrupt adjacent communication systems.

2. Generating high power tones within the site's transmit sub-system involves accessing the site's coaxial internal connections within the instrumentation enclosures. This can degrade system reliability.

3. Available standalone equipment capable of generating these high power signals and measuring the resulting passive IM is both expensive and inconvenient to use in a field environment.

A field-friendly instrument that is able to measure passive IM would dramatically enhance confidence in the performance of an RF communications site both following installation and during subsequent maintenance operations. Furthermore, a hand-held, battery operated instrument characterizing passive IM would allow for the quick and inexpensive measurement of this increasingly important site characteristic in a field environment by technician-level personnel. Ensuring the site's passive IM performance is within acceptable limits can enhance both the capacity and the quality of the communication channel.

### SUMMARY OF THE INVENTION

The present invention relates to an apparatus and methods for identifying unwanted interference in communication applications. In one application of the present invention, a portable instrument is provided with the capability to detect and identify the source of interference in an RF communications system. The instrument in one embodiment comprises one or more independent receivers (a plurality of receivers) controlled from a central controller. Each receiver utilizes a common sample clock which allows for time-synchronous (coherent) signal detection. According to another embodiment, the present invention comprises a method and an apparatus for measuring passive intermodulation in RF communications systems. A test instrument utilizing this method is compact, lightweight, and is operated from either battery or line (AC) power sources. An instrument in accordance with such an embodiment measures the passive intermodulation produced by the RF component or sub-system to which it is connected.

In accordance with an embodiment of the present invention, prior to interference detection, an understanding of the RF environment in the proximity of the interference problem is established. This is generally achieved by utilizing one or more methods, including: 1) referencing a data storage means that contains an internal database of licensed transmitters in the area (a regulatory license database); 2) referencing a data storage means that contains an internal database of unlicensed transmitters which are likely to be in the area; and/or 3) referencing a data storage means that contains an internal experience-based historical database of transmitters which the instrument of the present invention creates and updates based on measurements taken during the current and/or prior visits to the site.

The historical database is derived from the instrument's ability to automatically identify the presence of new transmitters in the area. This is achieved by comparing broad spectral sweeps with a very fine resolution across a wide bandwidth. These sweeps are compared to the historical data collected and stored within the internal data storage means for the current site. New transmitters are added to the database for future reference and comparison. The operator is notified of any new transmitters detected at the site. This helps the operator isolate potential sources of new interference since the last visit to the site.

Through the use of a plurality of receivers, both the interference and the associated transmitted signals can be simultaneously monitored. Using correlation techniques, the mathematical relationship between the hypothetical interference signature and the actual interference signature can be established. This relationship determines if the parent transmitter signals are likely related to the measured actual interference signals. In this way, the likely source of interference within a communications band can be readily identified quickly and efficiently.

To further aid in efficiently finding the source (or sources) of interference, in another aspect of the present invention an integral global positioning system (hereinafter “GPS”) receiver is utilized to determine a physical location of the test site. This information is used to access an internal database of all known transmitters in proximity of the test site. By knowing what transmitters are nearby, and knowing their power output and frequency ranges, the instrument automatically tunes itself to the critical test frequencies. This minimizes the expertise the operator must possess to operate the instrument and locate the source of interfering signals.

In another aspect of the present invention, the versatility of the measuring instrument may be further extended by including the ability to automatically determine the direction of arrival of measured interfering signals. When so equipped, the instrument of the present invention includes an interface to a directional (or steerable) antenna which provides a maximum (or minimum) signal output when pointed in the direction of the transmitter being evaluated. The user then enters the angular position of this antenna into the instrument. Alternatively, the instrument reads angular positions directly from the external antenna when it is equipped with a device which provides angular position relative to magnetic North (e.g. a flux gate). The received interference and transmitter signals are then measured with respect to not only frequency and time, but also with respect to angle of arrival and peak signal strength. This composite information set allows the further and more refined identification of transmitters which are causing interference which may not be included within the other sources of reference data.

As more than one transmitter (or combination of transmitters) may produce communication interference, the present invention identifies and lists all transmitters (or combination of transmitters) which can produce interference in the band of interest. Each transmitter (or combination of transmitters) is automatically or manually evaluated using both theoretical and empirical measurements. The results are presented to the user in one embodiment in the form of a score or graduated measurement. This score forms a ranking system that allows the most likely sources of interference to be quickly identified. A higher score means there's an increasing likelihood that a particular transmitter (or combination of transmitters) is responsible for generating interference in the band of interest. Alternatively, other types of output displays such as bar graphs, metering devices and other measurement devices commonly known in the art can be used for the same purpose.

When the evaluation is completed, a visual display of one or more reports are available to the user of the instrument detailing the reasons why it is believed that each transmitter (or combination of transmitters) is, or is not, responsible for generating interference in the band of interest. This report may then be presented to the party responsible for maintaining the transmitters involved in order to solicit help in mitigating the interference.

According to one embodiment, the present invention allows the measurement of passive IM in the field using a handheld, portable device. High power RF signals are not required to stimulate, and then characterize the passive IM resulting from the device or subsystem under test using this method of measurement. Instead, a noise signal, constrained in amplitude and bandwidth, is introduced to the system or device under test, and the presence of intermodulation signals is determined. This results in the following advantages over existing IM measurement solutions; and thus forming the numerous objects of the present invention:

1. The financial cost of the test instrument is reduced.

2. The physical weight of the test instrument is reduced.

3. The amount of RF energy radiated from the transmitter during the test is reduced in both power level and in signal duration thus minimizing the interference caused during the test.

4. The time required to perform the test is reduced due to the simplicity of the connections required to the device or subsystem under test.

In conceiving the present invention, it was appreciated that intermodulation is mathematically related to the signals that combine to produce intermodulation. This relationship is well documented in the literature. By generating, and then sampling a spectrum of signals within the transmit bandwidth of the RF component or sub-system under test, the expected intermodulation signals can be hypothesized. If these signals are correlated with the measured RF signals, the amplitude of the passive intermodulation generated by the device or sub-system may be characterized.

Additional advantages of the present invention will become readily apparent, particularly when taken together with the accompanying drawings.

### BRIEF DESCRIPTION OF THE DRAWINGS

FIG. 1 depicts a typical communication system showing two of potentially many transmitter-receiver pairs;

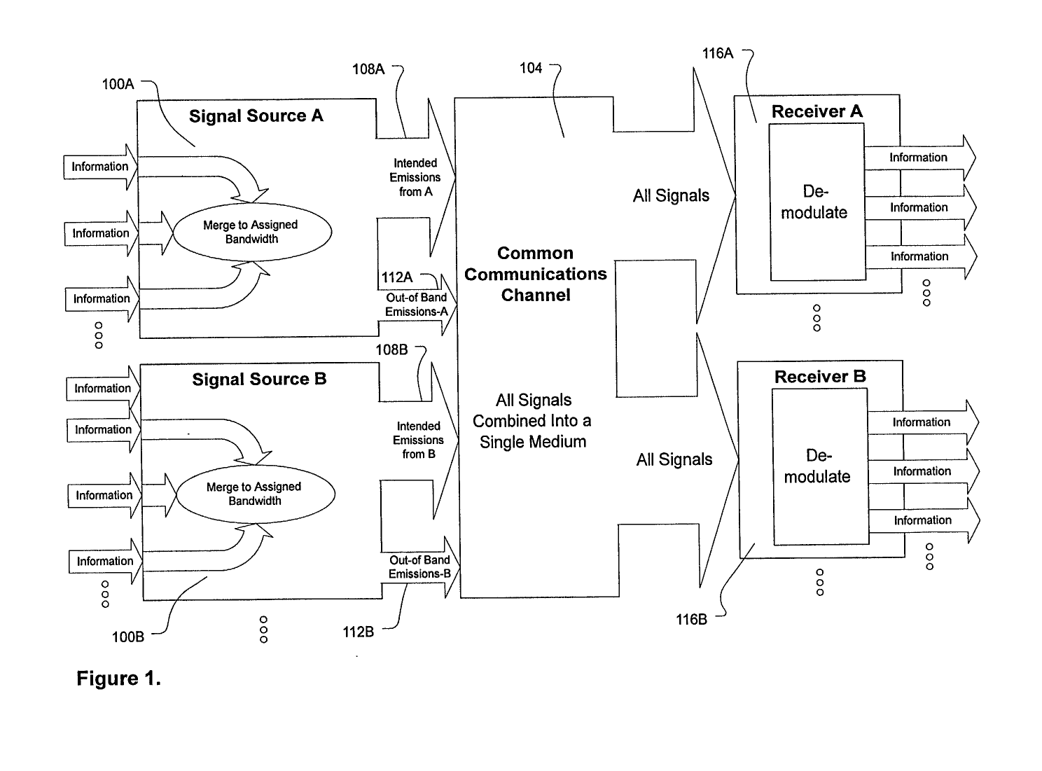

FIG. 2 is a block diagram illustrating an intermodulation measurement device in accordance with the prior art;

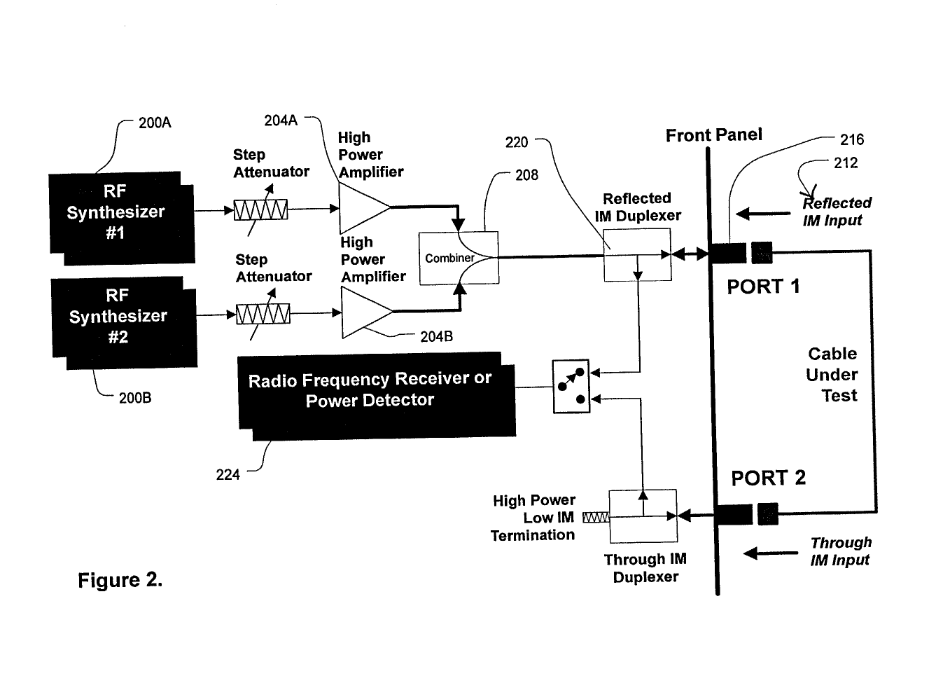

FIG. 3 depicts a device for measuring intermodulation in accordance with the prior art;

FIG. 4A shows the interference analyzer outer hardware visual display screen and accessory antenna, in accordance with an embodiment of the present invention;

FIG. 4B shows a simplified block diagram of an interference analyzer in accordance with an embodiment of the present invention;

FIG. 5 is a receiving hardware block diagram illustrating the application of a plurality of receivers to identify sources of interference in accordance with an embodiment of the present invention;

FIG. 6 is an information flow diagram illustrating a methodology to evaluate and identify interfering signals within a communications channel in accordance with an embodiment of the present invention;

FIG. 7 is an illustration of a method for identifying the intended emissions from one or more sources for generating a hypothetical out-of band emissions signature.

FIG. 8 is an illustration of a method to generate the hypothetical interference waveform from the measured parent waveforms in accordance with an embodiment of the present invention;

FIG. 9 is a block diagram depicting an instrument for detecting intermodulation in accordance with an embodiment of the present invention;

FIG. 10 is a top level functional flow diagram of a device for measuring passive intermodulation in accordance with an embodiment of the present invention;

FIG. 11 is a functional flow diagram illustrating a method for calculating expected passive intermodulation in accordance with an embodiment of the present invention;

FIG. 12 is a functional flow diagram illustrating the generation of a noise pulse using analog techniques in accordance with an embodiment of the present invention; and

FIG. 13 is a functional flow diagram illustrating the generation of a noise pulse using digital techniques in accordance with an embodiment of the present invention.

### DETAILED DESCRIPTION

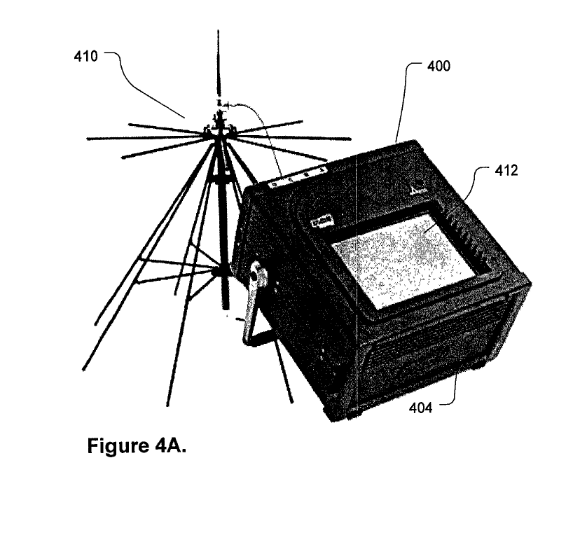

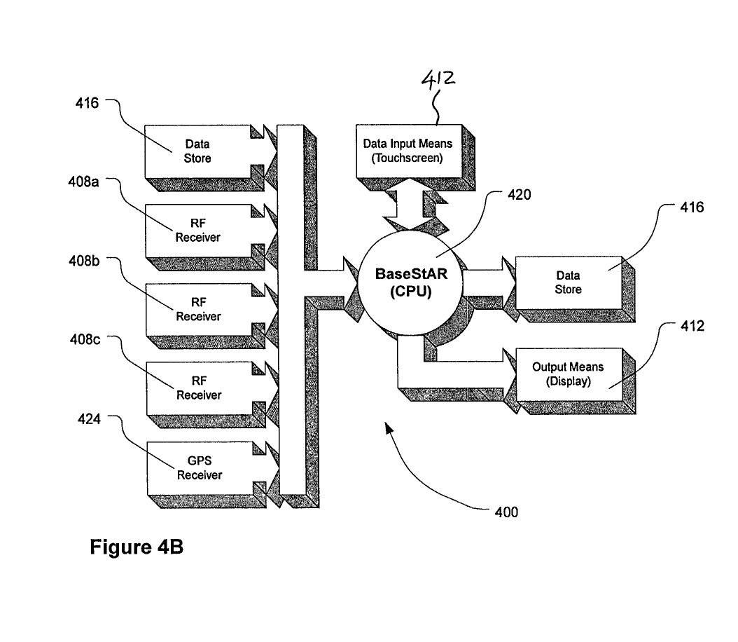

Referring now to the drawings, in one physical embodiment of the present invention, a device or instrument 400 is provided as shown in FIG. 4A. Within the instrument enclosure 404 are three wideband (50 MHZ to 2.3 GHz) receivers 408 (see FIG. 4B) designed for receiving signals from an antenna. The instrument also includes in one embodiment an on-board GPS receiver and integrated antenna. As appreciated by one skilled in the art, a stand-alone GPS receiving and antenna could also be used and interconnected to the enclosure to provide location information automatically or to provide latitude/longitude coordinates that can be used to manually enter the location of the measurement. using a map, The location at which the measurement is taken can also be entered manually by referring to a map. The instrument 400 is designed for field use and thus has a durable outer protective covering 404. Further, the instrument 400 can be operated through the touchscreen 412 interface in direct sunlight, or alternatively with a keyboard or other form of data input device could be used to input data or operating instructions.

The physical characteristics of the numerous components provided in the apparatus shown in FIGS. 4A and 4B are generally as provided below:

a) visual display and integrated touchscreen 412 interface readable in direct sunlight, or alternatively a keyboard, microphone, or other transducer could be used to input data or operating instructions;

b) a non-volatile memory 416 which provides a data storage means. This can be a flash disk, hard disk, or other data storage medium;

c) a central processing unit 420 used to interact with the operator, control the functions of the hardware, read/write to/from the data storage medium, and perform mathematical processing of the measured and stored data;

d) a GPS receiver 424 and integrated antenna. This function may be alternatively replaced by the manual input of location or map-based selection of current location; and

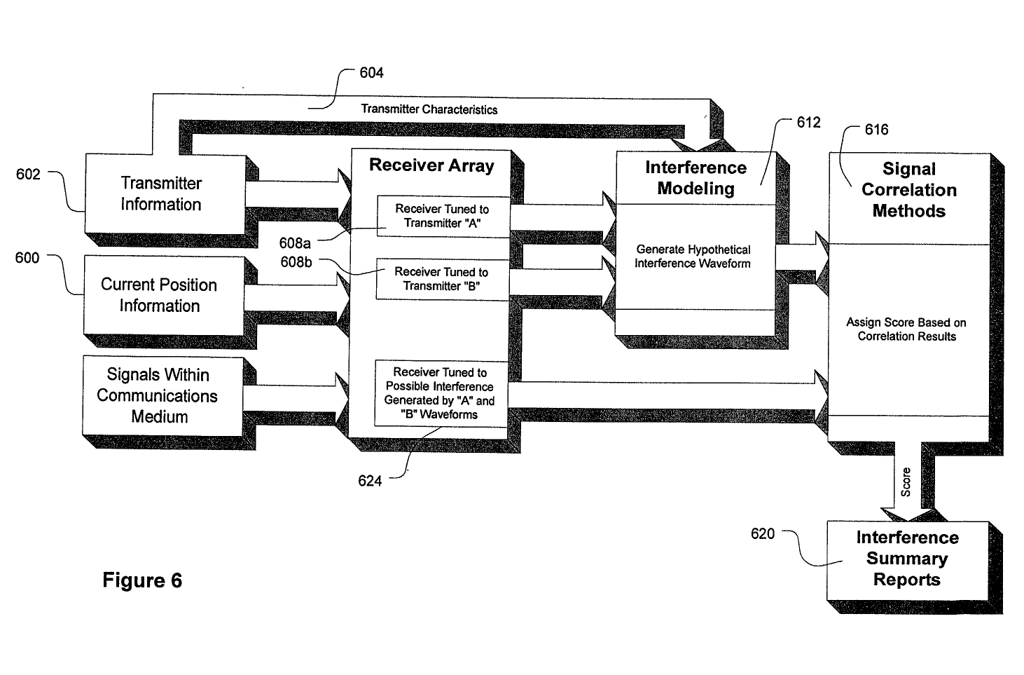

e) one, two, or three wideband receivers 408 designed for receiving signals from an antenna 410 as shown in FIGS. 4A and 6B. These receivers 408 are designed to tune across the frequency range of 50 MHZ to 2300 MHZ with a 15 MHZ instantaneous bandwidth (each). However, receivers covering a wider or narrower tuning range and having a wider or narrower instantaneous bandwidth may also be used as appreciated by one skilled in the art.

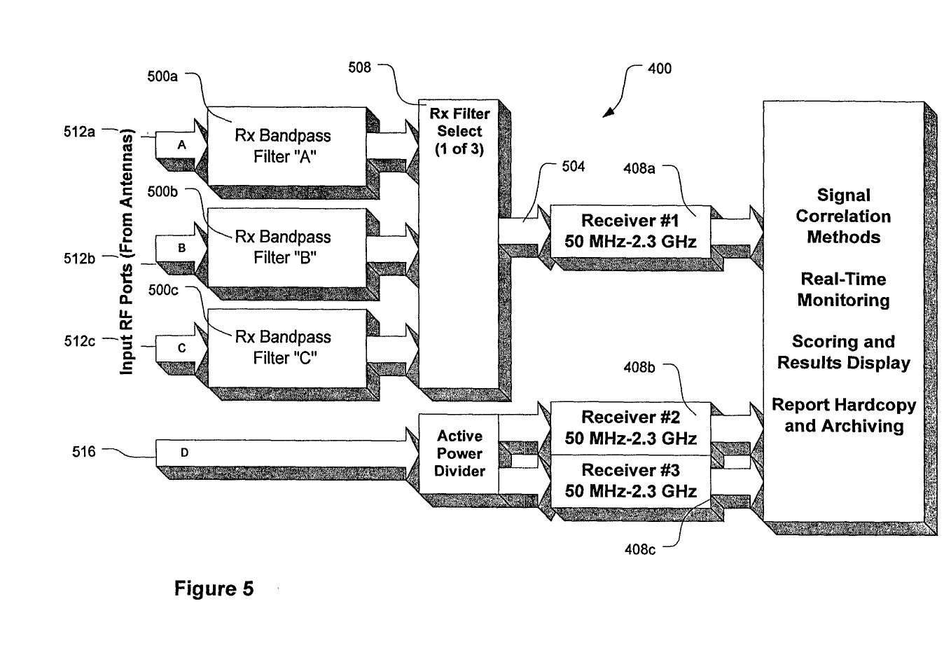

As illustrated in FIG. 5, one of the three receivers 408a within the instrument 400 may be preceded by a cavity bandpass filter 500. This filter's passband is tuned for operation within the frequency range of interest (where interference is to be detected). This filter 500 prevents the generation of instrument-induced interference (e.g. intermodulation) at the input 504 of the receiver 408a due to high power, out-of-band signals. A plurality of filters 500a-c may be provided, and an output from one of the filters 500 selected by an Rx filter select 508. The filters 500 may each receive a signal from the antenna 410 through inputs 512. The remaining receiver(s) 408b and 408c are connected directly to the wideband antenna 410 through an input 516 at the rear panel of the instrument 400. The two receivers 408b and 408c which are not preceded by a filter 500 are used to measure the parent carriers. These carriers are tested to see if they are responsible for generating interference in the band of interest.

Due to the nature of the signal processing used to correlate the transmitted signals with the resulting interference waveforms, the internal receivers 408 are capable of digitizing up to 15 MHz of alias-free bandwidth in a single data capture. This bandwidth corresponds to the maximum amount of bandwidth typically assigned to a single communications channel.

To increase the speed of the measurement process, the instrument 400 is preferably designed to measure signals both through a direct cable connection to the existing communications equipment, or through a supplied antenna 410. Utilizing the antenna 410 allows signals to be measured without physically connecting the instrument 400 to the existing communications equipment. This allows multiple communication sites to be quickly evaluated.

The instrument 400 functions by following a predefined sequence of events which lead to the detection and identification of the likely interference source. These events are described as set forth below in connection with the information flow diagram illustrated in FIG. 6.

The first step in one method of the current invention is to determine the context of the interference. In other words, the physical location where the interference is occurring has a direct impact on how the search for the cause of the interference is performed.

The method is initiated with the instrument 400 being physically located at the site which is experiencing interference, the position of the site is determined 600, and the instrument 400 is turned on. The current location of the instrument 400 is determined in one of four ways:

1. User-input Latitude/Longitude, which can be obtained from commonly known maps.

2. User-input map-based location (select on a map displayed on the visual display 412).

3. Selecting a previously defined benchmark location previously stored from a prior visit to the current location.

4. On-board GPS receiver 424 location data.

Once the instrument's 400 location is determined, a listing of transmitters 602 and their salient characteristics 604 within a user-defined radius of the current location is built. The transmitter information which is searched to build this list generally includes the following:

1. An internal licensed database of transmitters registered with the local regulatory agency. This data is contained within the internal data storage means 416.

2. User defined transmitters. This list, stored on the internal data storage means 416, consists of transmitters which have either been entered manually by the user or automatically entered based on measured spectrum measurements in prior or current visits to site location.

3. Default transmitters which are likely to exist, but are not specifically geographically licensed. Examples of such transmitters in the United States include, but are not limited to, cellular telephone service providers, amateur transmitters, and FCC Part 15 devices.

4. Transmitters Otherwise Identified. Using direction/position correlation, the instrument 400 compares the angle of arrival of signals and confirms their emissions frequency range and geographic location with those in the database. The angle of arrival is determined by a directional antenna which either physically rotates, or is electrically pattern-steered. If no match between angle of arrival, emissions frequency, and geographic position is detected, the detected emission is evaluated for possible interference generating characteristics relative to the band of interest. If it is possible for this newly identified transmitter to produce interference within the protected band (alone or in concert with one or more identified transmitters), then this transmitter is considered a new suspect. This suspect is then evaluated with the normal correlation algorithms described below to determine if it is actually responsible for causing interference in the band of interest.

The salient characteristics stored may include, but are not limited to:

1. Probable transmitter owner.

2. Transmitter frequency range of operation.

3. Transmitter output power, gain, and/or effective radiated power.

4. Transmitter location.

5. Probable modulation formats and type of information transmitted.

6. Transmitter call sign.

7. Additional information which is available for the geographic region in which the instrument is operated.

Because many licenses and users can exist for adjacent (or nearly adjacent) frequencies at the same location, the instrument 400 assumes a single radiating element is used for all of these frequency bands. A single (or several) larger bandwidth transmitters are synthesized from many, many smaller bandwidth, but co-located transmitters listed in the database. This task is known as band concatenation and significantly reduces the amount of time spent evaluating transmitters as to their responsibility for causing interference.

To improve the speed and flexibility of these database operations, ODBC compliant databases and queries are used to track lists of transmitters and suspects in each historical location where the instrument 400 has been used.

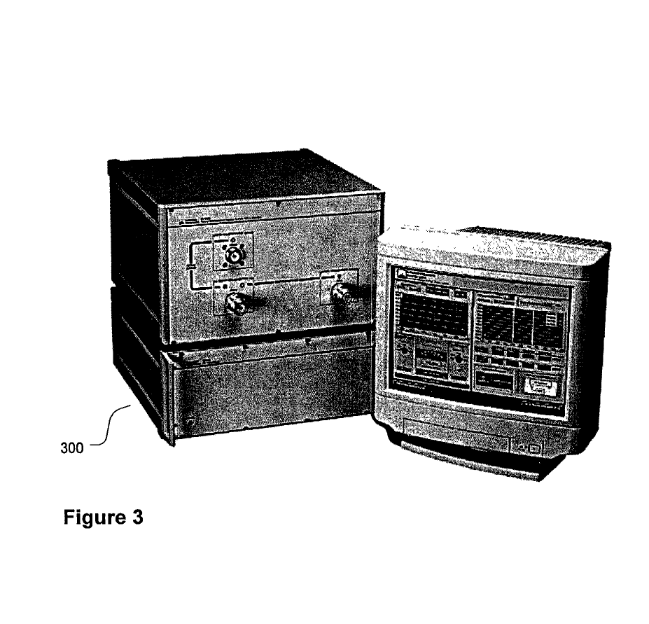

Once all of the nearby transmitters are known to the instrument 400, the user then specifies which band (or bands) of frequencies 608 are to be evaluated for the presence of interference. With this information, the instrument 400 is able to evaluate each proximal transmitter individually, and combinations of transmitters severally (612 and 616) to determine if it is mathematically possible for interference to be generated within the band of interest. Each transmitter, or combination of transmitters that can generate interference is designated as a “suspect” and placed in a listing 620 presented to the user. This list forms a hypothetical list of transmitters that can generate interference within the specified frequency range. The data generated from this method is illustrated generally in FIG. 3.

In one embodiment of the present invention, the instrument 400 uses the following mathematical relationship to determine if the frequency range of suspect transmitters' intended emissions can cause interference landing within the receive band of interest:

F_{H}(n,m)=MAX{nf_{A}±mf_{B}} for all F_{Alow}≦F_{A}≦F_{Ahigh} and F_{Blow}≦F_{B}≦F_{Bhigh}

F_{L}(n,m)=MIN{nf_{A}±mf_{B}}F_{Alow}≦F_{A}≦F_{Ahigh} and F_{Blow}≦F_{B}≦F_{bhigh}

and for all n≦N and m≦M

where:

F_{H} is the high frequency limit of the resulting interference waveform.

F_{L} is the low frequency limit of the resulting interference waveform.

F_{Alow} is the low frequency limit of the “A” transmitter waveform.

F_{Ahigh} is the high frequency limit of the “A” transmitter waveform.

F_{Blow} is the low frequency limit of the “B” transmitter waveform.

F_{Bhigh} is the high frequency limit of the “B” transmitter waveform.

N, M are the maximum order coefficients for the intermodulation product which can land a frequency within the frequency band of interest.

If this interference frequency range falls within, or is a part of the frequency range of interest, the union of the two frequency ranges is monitored 624 for interference and subsequent correlation 616 to the parent emissions. Using this and prior historical knowledge of the transmitter/interference frequency relationship, the instrument 400 spends time measuring only signals which have a mathematical possibility of generating interference in the band of interest.

Each suspect which can generate interference is given a preliminary ranking or score depending upon several factors. Some of these factors include but are not limited to:

1. Power output of the transmitter(s);

2. Distance to the transmitter(s);

3. Distance between the transmitters;

4. The frequency of the transmitter(s) and the associated interference signal; and

5. The order of the intermodulation (“IM”) product produced by the transmitter landing within the band of interest.

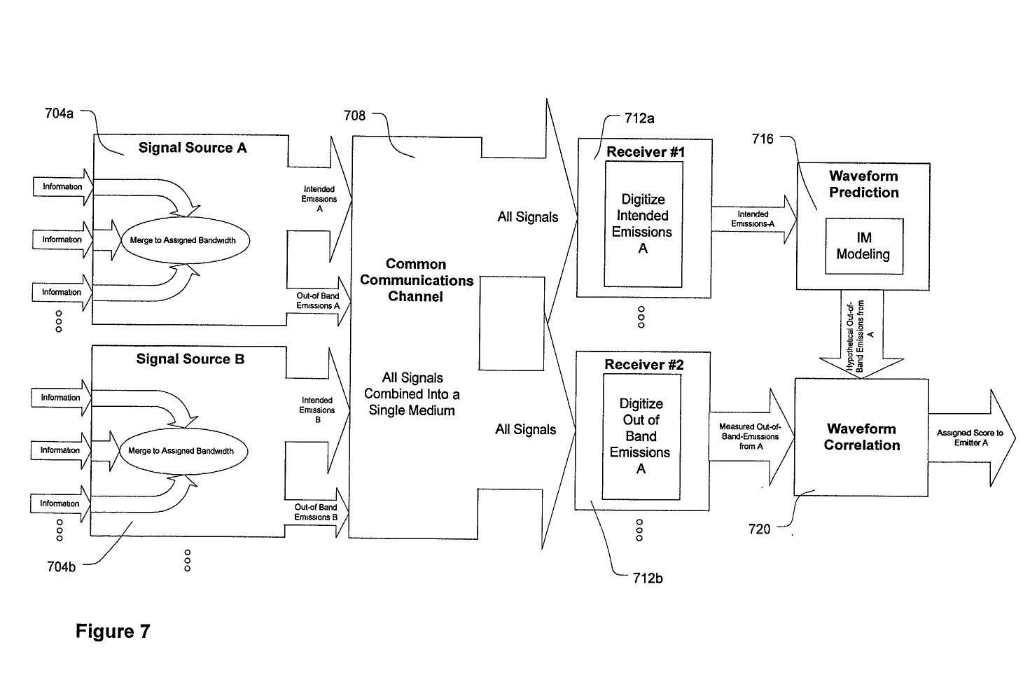

The ranked suspect (hypothetical interferer) list 620 is used as a starting point for empirical measurements to further refine the score. The process of empirical measurement is generally illustrated in FIG. 7 In particular, FIG. 7 illustrates the reception of signal sources 704a and 704b, and the combination of the received signals 704 into a common communications channel 708. With respect to the signal from the first signal source 704a, the intended emissions are digitized in a first receiver 712a, while the out of band emissions from the communications channel 708 are digitized in a second receiver 712b. The intended emissions are passed from the first receiver 712a to a wave form prediction unit 716, which performs IM modeling to produce a hypothetical out of band emission signature. The hypothetical out of band emissions from the wave form prediction unit 716 are correlated with the measured out of band emissions received from the second receiver 712b in a wave form correlation unit 720. A scoring, representing the likelihood that the first signal source 704a is the source of the measured out of band emissions is generated to allow the signal source 704a to be ranked within the listing 620 (see FIG. 6). As can be appreciated by one of ordinary skill in the art, the process illustrated in FIG. 7 is repeated for each signal source 704 considered by the instrument 400. The correlation methods used to refine the list include Complex Signal Correlation and Spectral Event Correlation, are discussed herein below.

The instrument's internal controller and inherent software determines how each of the three receivers 408 will be tuned by relying on the fundamental relationship between a transmitter's intended frequency emissions and range of interference frequencies which will be generated by these intended emissions. Alternatively, a stand alone personal computer (PC) could be used to accomplish the same purpose. The spectral signature (magnitude and phase) of this interference (otherwise known as the hypothetical interference signature) is readily calculated by mathematically combining the measured signatures of the parent transmitted waveforms.

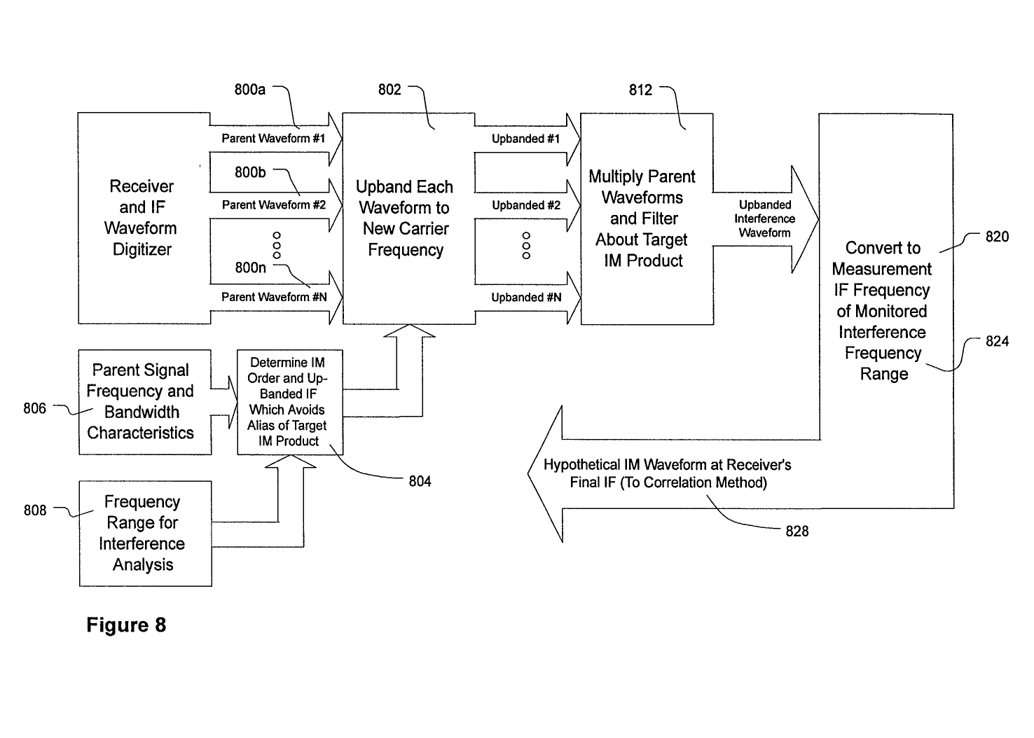

It should be noted that the following description generally describes two parent transmission waveforms 800a and 800b (see FIG. 8) to provide a concise and clear description of the method used. It should be recognized, however, that this method applies equally to an arbitrary number of waveforms which can combine to generate an interference waveform.

The signal flow to generate the interference signature is shown in FIG. 8. The parent transmission wave forms 800 are up-banded 802 from the original intermediate frequency (IF) frequency sampled by the receiver to a higher IF frequency that avoids aliasing the target IM product 804. The IM order and up-banded IF is determined from the parent signal frequency and bandwidth characteristics 806 and the frequency range over which the interference analysis is to take place 808. This higher frequency is selected as the lowest frequency which can contain the following:

BW=(n+m)*[(F_{Ahigh}−F_{Alow})+(F_{Bhigh}−F_{Blow})]

where

BW is the IM coefficient on the “A” carrier which, in combination with the specified “m” value, produces an IM response within the band of interest.

n is the total bandwidth occupied by the IM signal created by the combination of the “A” and “B” waveforms.

m is the IM coefficient on the “B” carrier which, in combination with the specified “n” value, produces an IM response within the band of interest.

F_{A} is the high and low end of the “A” RF waveform frequency range.

F_{B} is the high and low end of the “B” RF waveform frequency range.

Once up-banded, the two waveforms are combined 812 to generate the expected interference waveform that would be produced by these two carriers. A variety of mathematical techniques may be used to perform this combination. One implementation is a simple polynomial expansion whose order matches the order of the intermodulation product that will produce an interference signal within the band of interest. This expression is given by:

$${h}_{i} = \frac{{g}_{i}}{2} + {\sum }_{i = 0}^{( R - 3 ) / 2} {a}_{i} {g}_{i}^{i} for even R$$

$${h}_{i} = \frac{{g}_{i}}{2} + {\sum }_{i = 0}^{( R - 2 ) / 2} {a}_{i} {g}_{i}^{i} for odd R$$

qᵢ=BPF(hᵢ)

where:

R=n+m

$$g ( i ) = \frac{{x}_{i} {y}_{i}}{MAX \{ {x}_{i} {y}_{i} \}}$$

and:

hᵢ is the unfiltered non-linear combination of the two transmit waveforms xᵢ and yᵢ.

aᵢ are the coefficients utilized in the polynomial expansion which is used to combine the two waveforms xᵢ and yᵢ. Normally, a₀=0, a₁=0.5, and all other values of a are equal to −1. However, improved correlation results can be obtained by tailoring these coefficients to match the actual non-linear phenomenon which is causing the interference.

qᵢ is the signal hi bandpass filtered about the center frequency of the expected interference signal with a bandwidth which matches the union of the expected interference bandwidth and the bandwidth of interest. Normally an FIR bandpass filter is used, although others are filter implementations are equally applicable.

R is the sum of the integer multipliers on each of the waveforms which are combining to produce the interference waveform. Also referred to as the “order” of the intermodulation product.

xᵢ is the measured waveform of the first transmit signal

yᵢ is the measured waveform of the second transmit signal

A feature of significance in the above calculations is that the method of calculating odd and even order interference is unique. By splitting the calculations in this way, the content of the resulting expected interference is minimized to contain only the spectral products which can land within the frequency range of interest. Sample-domain signal content which falls outside the band if interest is minimized thus increasing the sensitivity of the subsequent correlation process. Further, by truncating the order of the polynomial expansion to match the order of the IM coefficients which cause the resulting interference waveform to fall within the frequency range of interest, the computations are made more efficient due to a minimized sample rate requirement.

A second, more computationally efficient method which can be used to combine the transmit waveforms is given by:

$${h}_{i} = {\sum }_{i = 0}^{R} [ \frac{{x}^{( R - i )} {y}^{i}}{i !} {\prod }_{k = 0}^{i - 1} ( R - k ) ]$$

qᵢ=BPF(hᵢ)

The disadvantage to this second method is that the spectral content of the resulting waveform cannot be readily tailored to match only the responses of interest within frequency band of interest.

Using either technique and other similar methods, the signal resulting from the combination 812 of the up-banded “A” and “B” waveforms is down-converted 820 to the same IF frequency utilized by the instrument's receiver. The signal is then decimated 824 to match the sampling rate of the receiver. Matching the expected IM waveform's characteristics (IF frequency and sampling rate) allows the cross-correlation between this expected (or hypothetical) and the actual measured interference waveform to be readily performed.

At this point, the interference signature which would be produced by the suspect transmitter(s) is digitally and completely represented within the instrument at the sampling rate and IF frequency of the receivers. Because the instrument's internal receivers perform coherent and simultaneous sampling, the hypothetical complex interference waveform 828 derived above can be correlated with the actual measured interference waveform. The degree of correlation can be used to determine if the transmitters being tested are responsible for the measured interference. The expression used to perform the signal correlation is given by:

R_{xy}_{ᵢ}=r_{i-(N-1)}fori=0,1,2 . . . (2N−1)

$${r}_{i} {\sum }_{k = 0}^{N - 1} {q}_{k} {\hat{q}}_{j + k} for j = - ( N - 1 ) , - ( N - 2 ) , … ( N - 1 )$$

where:

q is the filtered, expected interference waveform at the measurement sample rate and IF frequency.

\hat{q} is the filtered, measured interference waveform at the measurement sample rate and IF frequency.

R_{xy} is the cross correlation of the measured and expected interference waveforms.

This prediction and correlation method is conceptually illustrated by the block diagram provided in FIG. 8. One exceptional advantage to this technique is that interference signals which appear nominally below the magnitude noise level of a typical spectrum analyzer can still produce clear correlated agreement with the hypothesized interference waveform. Because a complex correlation is performed, both magnitude and phase information is leveraged to detect if a relationship exists between the measured interference and the suspect transmitters even when the presence of interference might not be visible with a traditional scalar spectrum analyzer.

A second benefit of utilizing complex signal correlation to detect interference is its relative immunity to the presence of normal communications traffic during testing. This is important as it allows for normal communication systems operation while interference is being detected and the source of the interference is being identified.

The sample and frequency domain characteristics of the cross-correlation result are used to generate a change in relative score (relative ranking in the suspect list) for the specific suspect transmitter pair under evaluation.

The Event Correlation Technique evaluates the measured power envelope of both the transmitter(s) and the interference bands. This envelope is continuously sampled in both frequency and time. Co-incident occurrences of power envelope changes (increases or decrease in power level or shifting of frequency) indicate an increased statistical likelihood that the transmitters being measured are responsible for the interference being measured. The expression used to evaluate the occurrence of correlated events is:

$${S}_{{A}_{j}} = σ \{ {A}_{j} ( f ) \} for j = 0 , 1 , 2 , … J$$

$${E}_{{A}_{j}} = TRUEiff \vert {A}_{j} - {A}_{j - 1} \vert > k * {S}_{{A}_{j}}$$

where:

S_{A}_{_{J}} is the standard deviation of the last (most recent) “J” samples at a frequency “f”

E_{A}_{_{J}} is a Boolean indicating the detection of a spectral event (power envelope transition) for the waveform “A”

If an event is detected at the same time in any of the monitored transmit spectra and an event is detected in the monitored band of interest, the occurrence of a correlated spectral event is recorded. The number and location of these events are used in generating a relative score for the suspect transmitters being monitored.

To aid in describing the following capability, let the word “suspect” represent one transmitter, or a combination of transmitters, that is capable of generating interference within the band of interest.

As more than one suspect can be simultaneously generating interference within the band of interest, the instrument 400 includes the ability to track each suspect with a score. The score is incrementally adjusted with each successive test. When the instrument 400 has completed a measurement operation, the list of suspects is re-ranked in order of decreasing likelihood of being a cause of interference in the band of interest. The suspects appearing at the top of the list are the most likely causes of the interference that is degrading communication system quality and/or capacity. Those appearing at the bottom of the list are the suspects least likely to be causing interference within the band of interest. This information is conveyed in the visual display and/or transmission of reports indicated in FIG. 6.

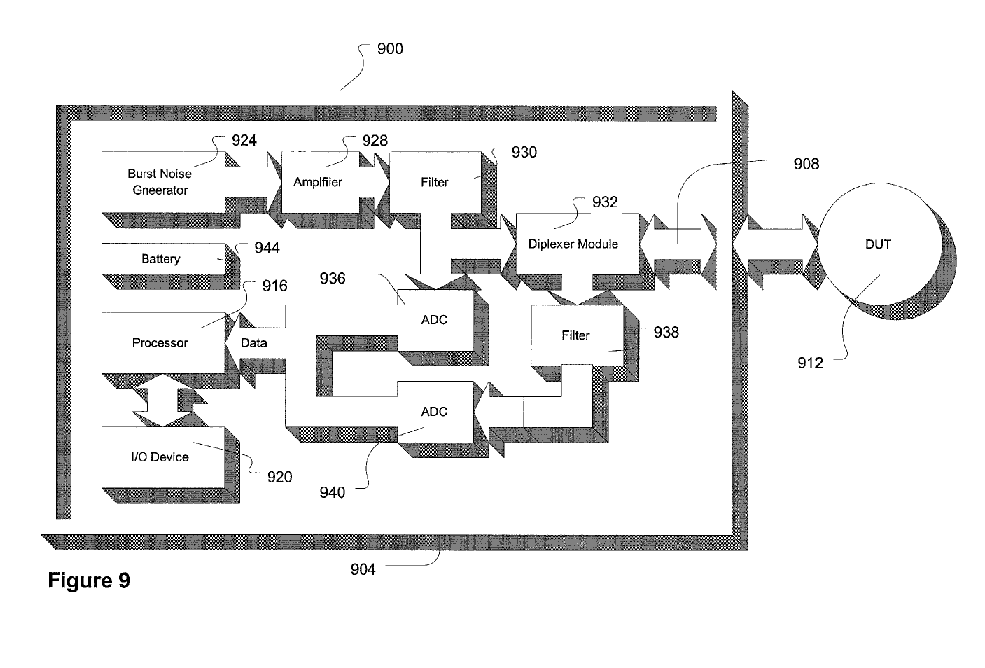

With reference now to FIG. 9, an instrument 900 according another embodiment of the present invention is illustrated in block diagram form. In general, the instrument 900 includes a ruggedized enclosure 904, housing the major components of the instrument 900. A connector 908, such as a coaxial connector, is provided for interconnecting the instrument 900 to the device under test (DUT) 912. In accordance with one embodiment of the present invention, the enclosure 904 is dimensioned so that the instrument 900 is easily portable, and can therefore be easily transported to the location of the device under test 912. In accordance with an embodiment of the present invention, the instrument 900 is a hand held device.

Within the enclosure 904 is a processor 916. The processor 916 may include any programmable processor, including a field programmable gate array, or an application specific integrated circuit. In general, the processor 916 coordinates and controls the operation of the instrument 900, including the detection of passive intermodulation produced within the device under test 912.

An input/output device 920 is provided for receiving commands and data, and for outputting data to the user. The input/output device 920 may include a single input/output device, such as a touch screen display, or separate devices for receiving input and providing output. For example, the input/output device 920 may include a liquid crystal display in combination with a keyboard. The input/output device 920 may further include, but not be limited to: a printer; a mouse; or any other type of pointing device; a microphone for receiving voice activated commands; and a speaker. As a further example, in accordance with an embodiment of the present invention, the input/output device 920 includes a button to initiate the test and a red/green LED to indicate a pass/fail status of the device under test 912.

A burst noise generator 924 generates a test signal having a selected band of frequencies, as will be described in greater detail below. According to one embodiment of the present invention, different burst noise generators 924 may be used in connection with different RF systems or devices under test 912. For example, a first module containing a first burst noise generator 924 capable of generating noise within a first band of frequencies relevant for use in connection with a cellular frequency system 912 may be available. In addition, a second module containing a second burst noise generator 924 capable of generating noise within a second band of frequencies relevant for use in connection with a PCS-frequency system 912 may be available. A user of the instrument 400 may interconnect the appropriate module to the instrument 400, depending on the type of system 912 under test. Alternatively or in addition, the burst noise generator 924 may be programmable to provide user selected frequency bands.

An amplifier 928 is provided for amplifying the test signal generated by the burst noise generator 924. A filter 930 may also be provided to filter the amplified noise signal. The test noise signal is received by a diplexer module or assembly 932, which injects the test signal into the device under test 912 through the connector 908. In addition, the test signal is provided to an analog to digital converter 936, which samples and digitizes the test signal, and provides the digital representation of the test signal to the processor 916.

The diplexer module 932 may include a filter for filtering the test signal before it is provided to the device under test 912. The signal produced by the device under test 912, in response to the injection of the test signal, is received through the connector 908 at the diplexer module 932 filtered by a filter 938 that may be separately provided or included as part of the diplexer module 932, and provided to a second analog to digital converter 940. The signal from the second analog to digital convertor 940 is then provided to the processor 916 for analysis and comparison to the test signal, as will be described in greater detail below.

The instrument 900 may include a battery 944 for powering the various components. Alternatively or in addition, the instrument 900 may utilize AC line power or some other source of electrical power.

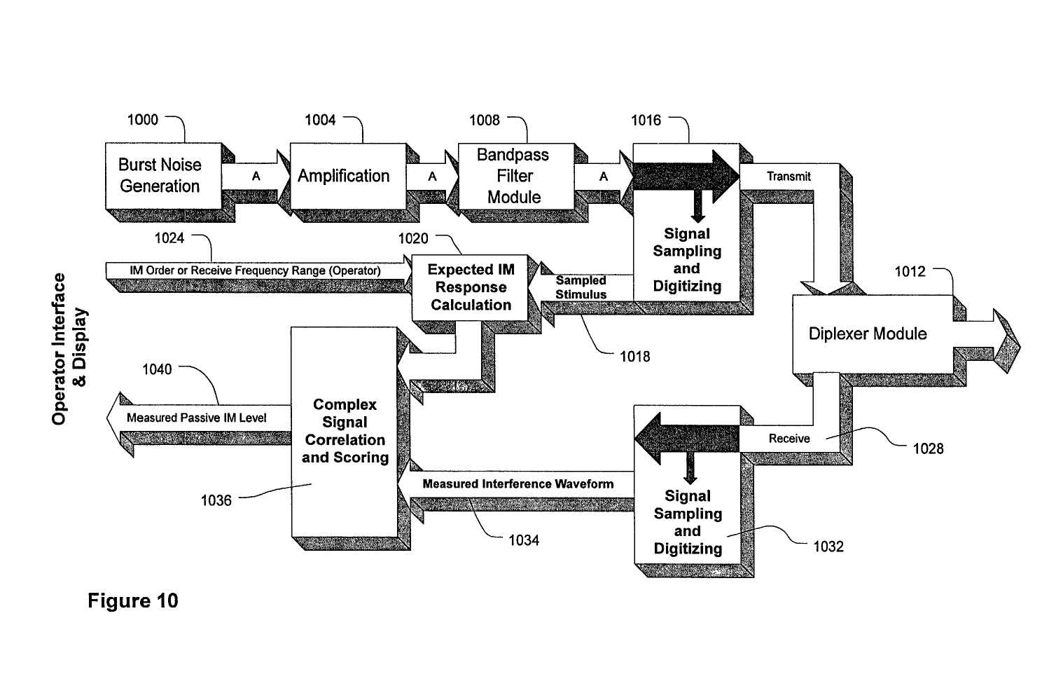

With reference now to FIG. 10, a top level block diagram, depicting the operation of the embodiment of the present invention illustrated in FIG. 9, is shown. The basic signal flow within the instrument 900 begins with the generation of a short (<1 second) signal burst having a shaped noise spectral density 1000 by the burst noise generator 924. This noise burst signal is amplified 1004 in the amplifier 928 and then filtered 1008 by the filter 930 prior to being sampled 1016. According to one embodiment of the present invention, the filter 930 implements a band pass filter. Following sampling 1016, the signal is routed 1012 through a diplexer/filter assembly 932 to a common coaxial connector port 908. The noise burst passes into the device under test (DUT) 912 and is either radiated from, or terminated within, the DUT 912.

The signal 1028 returning from the DUT 912 contains both the original noise burst and the resulting intermodulation products. The diplexer/filter assembly 1032 allows only the IM products through to the receive-side sampler 940. After the IM signal returned from the DUT 912 is sampled and digitized 1032, it is then cross-correlated 1036 with a mathematically manipulated signal derived from the outgoing noise burst. If the signals are well correlated, this indicates the presence of IM in the returned signal 1028. If the signals are not correlated, this indicates there is a lack of signals caused by IM within the DUT 912. This information is processed to produce an indication to the operator which shows the relative passive IM performance of the DUT.

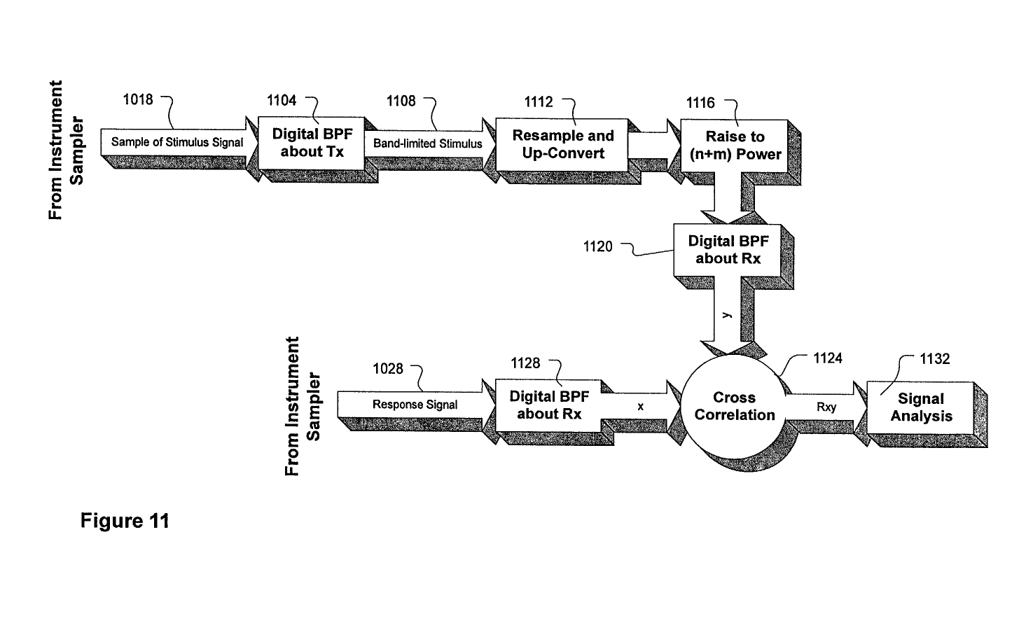

FIG. 11 illustrates how the expected IM signal is derived from the band-limited noise burst which is injected into the DUT 912. The sample of the noise burst 1018 is digitally filtered 1104 to band limit the response. This filtered signal 1108 is then re-sampled and up-converted 1112 to a higher frequency. This allows for spectral growth (increased bandwidth) of the signal without aliasing when it is subsequently raised to the R=(n+m) power. The signal is then self-multiplied (raised to the R^{th} power) 1116, and a digital bandpass filter is applied 1120 to select only that portion of the resulting spectrum which falls within the frequency range of interest. Typically, this is the frequency range corresponding to the mobile-transmit (base station receive) operation. The signal is then decimated back down to the IF sampling frequency used by the instrument. This allows for rapid cross-correlation processing with the measured IM signal 1124.

The response signal (i.e. the signal 1028 received from the DUT 912 in response to the injection of the test signal) is digitally bandpass filtered 1128 about the frequency of interest. After cross correlation 1124 of the filtered response signal and the filtered noise burst, signal analysis 1132 is performed.

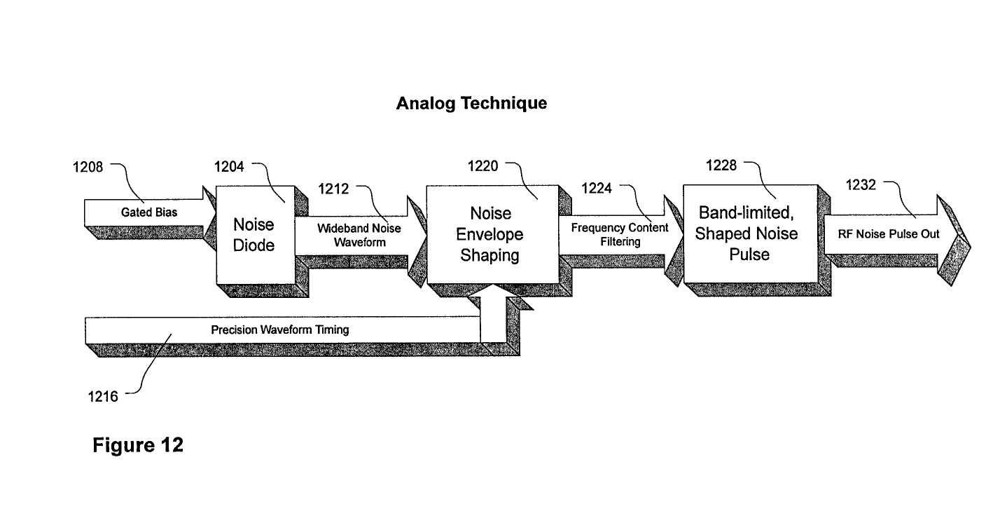

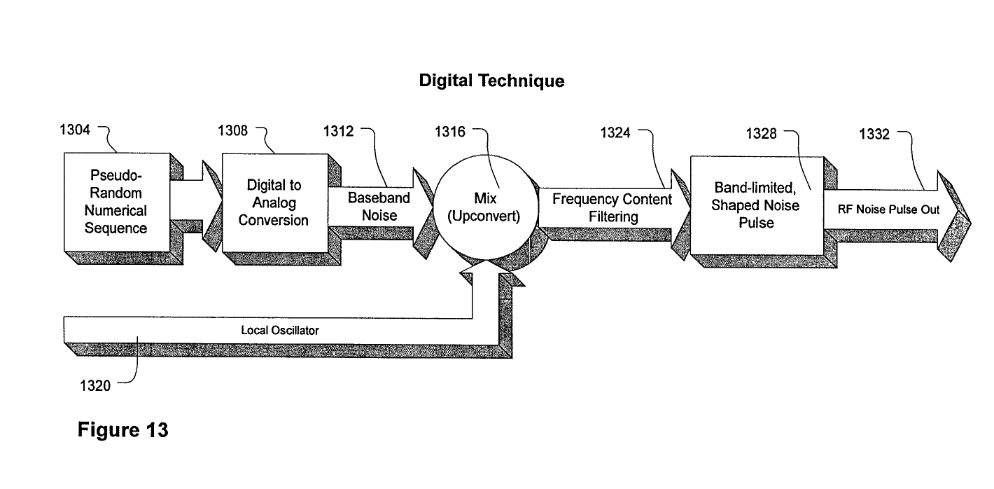

Block 924 within FIG. 9 shows the “Burst Noise Generator.” Two different implementations of this block are illustrated in FIGS. 12 and 13. Although a wide range of techniques are available to produce the required random noise pulse, FIGS. 12 and 13 illustrate two of the more cost-effective techniques. In the first approach, illustrated in FIG. 12, purely analog processing is used to generate the noise pulse. To conserve power, a noise diode 1204 is biased 1208 just prior to and during the generation of the noise pulse 1212. The shape (envelope) of this pulse is formed by a timing waveform 1216 applied to a solid-state switch 1220. The output of this switch is subsequently filtered 1224 to match the energy content of the pulse to the bandwidth of the device under test 912. The resulting frequency band and time-limited pulse 1228 is then amplified to a high peak power level, and transmitted 1232 to the device under test 912.

A second, digital implementation of a burst noise generator 924 is illustrated in FIG. 13. According to this embodiment, a pseudo-random numerical sequence 1304 is generated. The pseudo-random numerical sequences 1304 is then converted to an analog signal 1308, and the resulting baseband noise 1312 is provided an up-converter 1316. The up-converter 1316 is driven by a numerically controlled local oscillator 1320. The output of the up-converter 1316 is then filtered 1324, and the resulting frequency band and time-limited pulse 1328 is amplified to a high peak power level and transmitted 1332 to the DUT 912. This approach has the advantage of the instrument being able to tailor the specific content of the waveform to match the characteristics of the device under test 912. The signal content of the resulting noise waveform is well defined which aids in the coherent processing of the intermodulation-contaminated response from the device under test 912.

The methods and apparatuses described herein with respect to the detection of passive IM focus on minimizing the unit cost of the test instrument 900 and on minimizing power consumption. The result is a handheld, battery operated field instrument which is sufficiently low in cost to allow an instrument to be included with each service vehicle operated by a wireless system provider.

To stimulate passive intermodulation within the device under test (DUT), significant levels of power are typically required. A typical specification used for the measurement of passive IM on a test bench is 2×20W CW carriers combined into a single coaxial port. The resulting IM response which is typically considered acceptable in cable assemblies and antennas is −110 to −120 dBm with this stimulus.

To conserve battery power, a high peak power, short duration pulse (e.g. 100 microseconds to tens of milliseconds) is utilized to stimulate the desired passive IM response. Although there are a variety of methods to produce this stimulus signal, one of the more efficient utilizes a shaped waveform from a pulse-stimulated noise diode. FIGS. 12 and 13 both illustrate such an approach.

The digitized sample of the transmitted signal is processed as shown in FIG. 11. The signal is digitally filtered to further limit the bandwidth. The signal is then used within a polynomial expansion to simulate IM products up to the highest order IM product being tested (but no more). The highest order IM product being tested may be entered by the technician, or may be predetermined by the instrument 900. This process is given by:

$${h}_{i} = \frac{{g}_{i}}{2} + {\sum }_{i = 0}^{( R - 3 ) / 2} {a}_{i} {g}_{i}^{i} for even R$$

$${h}_{i} = \frac{{g}_{i}}{2} + {\sum }_{i = 0}^{( R - 2 ) / 2} {a}_{i} {g}_{i}^{i} for odd R$$

qᵢ=BPF(hᵢ)

where:

R=n+m

$$g ( i ) = \frac{{x}_{i} {y}_{i}}{MAX \{ {x}_{i} {y}_{i} \}}$$

and:

hᵢ is the unfiltered non-linear combination of the two transmit waveforms xᵢ and yᵢ.

aᵢ are the coefficients utilized in the polynomial expansion which is used to combine the two waveforms xᵢ and yᵢ. Normally, a₀=0, a₁=0.5, and all other values of a are equal to −1. However, improved correlation results can be obtained by tailoring these coefficients to match the actual non-linear phenomenon which is causing the interference.

qᵢ is the signal hᵢ bandpass filtered about the center frequency of the expected interference signal with a bandwidth which matches the union of the expected interference bandwidth and the bandwidth of interest. Normally an FIR bandpass filter is used, although other filter implementations are equally applicable.

R is the sum of the integer multipliers on each of the waveforms which are combined to produce the interference waveform. Also referred to as the “order” of the intermodulation product.

xᵢ is the measured waveform of the first transmit signal

yᵢ is the measured waveform of the second transmit signal.

The resulting signal contains both the original noise burst transmitted into the device under test as well as intermodulation products up to an order “R”. The frequency band corresponding to the desired IM product is calculated by

F_{H}(n,m)=MAX {nf_{A}±mf_{B}} for all F_{Alow}≦F_{A}≦F_{Ahigh} and F_{Blow}≦F_{B}≦F_{Bhigh}

F_{L}(n,m)=MIN {nf_{A}±mf_{B}}F_{Alow}≦F_{A}≦F_{Ahigh} and F_{Blow}≦F_{B}≦F_{Bhigh}

and for all n≦N and m≦M

where:

F_{H} is the high frequency limit of the resulting interference waveform.

F_{L} is the low frequency limit of the resulting interference waveform.

F_{alow} is the low frequency limit of the “A” transmitter waveform.

F_{Ahigh} is the high frequency limit of the “A” transmitter waveform.

F_{Blow} is the low frequency limit of the “B” transmitter waveform.

F_{Bhigh} is the high frequency limit of the “B” transmitter waveform.

N, M are the maximum order coefficients for the intermodulation product which can land a frequency within the frequency band of interest.

These frequency limits are used to filter the processed sample waveform so that it is band-limited to only those frequencies corresponding to the IM order of interest. The resulting waveform is the expected intermodulation signal which would result from the DUT if it generated a passive IM response.

Following launching the noise pulse into the device under test, the power consumed by the transmitter circuitry is significantly reduced by placing the noise generator and amplification stages in a ‘sleep’ mode. The receive circuitry (e.g., the diplexer module 932, analog to digital converter 940 and processor 916 shown in FIG. 9), however, operates until the pulse is returned from the device under test and is fully processed.

The generated passive IM signals are typically at a very low power level. This requires a sensitive receiver which must be protected from the high peak powers reflected from the device under test. According to an embodiment of the present invention, a bandpass filter network is utilized to reject the transmit-band noise pulse and allow the receive-band IM signals to pass with minimal insertion loss. This filter network is shown in FIG. 10 as part of the diplexer module.

The physically filtered receive signal is further processed with a bandpass digital filter having similar characteristics to the filter used on the sample of the transmitted noise pulse. The resulting signal is now cross correlated with the mathematically modeled intermodulation response using the following:

R_{xy}_{ᵢ}=r_{i-(N-1)} for i=0,1,2, . . . (2N−1)

$${r}_{i} {\sum }_{k = 0}^{N - 1} {q}_{k} {\hat{q}}_{j + k} for j = - ( N - 1 ) , - ( N - 2 ) , … ( N - 1 )$$

where:

q is the filtered, expected interference waveform at the measurement sample rate and IF frequency.

\hat{q} is the filtered, measured interference waveform at the measurement sample rate and IF frequency.

R_{xy} is the cross correlation of the measured and expected interference waveforms.

A relatively high value of R_{xy} indicates the presence of intermodulation signals within the device under test. A relatively low value of R_{xy} indicates the lack of intermodulation signals within the device under test. This relative amplitude information is used to drive a user-viewable display which indicates the relative level of passive IM signals which will be generated by the device under test during normal operation.

Although the present invention has been described in conjunction with its preferred embodiments, it is to be understood that modifications and variations may be resorted to without departing from the spirit and scope of the invention as those skilled in the art readily understand. Such modifications and variations are considered to be within the purview and scope of the invention and the appended claims.

What is claimed is:

1. A portable test device adapted to measure passive intermodulation in a radio frequency communication system, comprising:
a power source;
a burst noise generator interconnected to said power source to create a predetermined signal;
an amplifier to increase said signal and create an amplified signal;
a filter for filtering band noise from said amplified signal;
a sampling means for sampling and digitizing said amplified signal;
a transmitter for transmitting said amplified signal through a test apparatus associated with the radio frequency communication system and to create a transmitted amplified signal;
a receiver for receiving said transmitted amplified signal after it has passed through the test apparatus of the radio frequency communication system; and
a processor means for comparing and correlating said transmitted amplified signal with said amplified signal, wherein the passive intermodulation in the test apparatus of the radio frequency communication system can be measured.

2. The portable test device of claim 1, wherein the burst noise generator is placed into a sleep mode for a predetermined period of time after creating said predetermined signal to preserve power in said power source.

3. The portable test device of claim 1, wherein said amplified signal has a pulse width between about 100 microseconds and 1 second.

4. The portable test device of claim 1, wherein said predetermined signal created by said burst noise generator is a short duration high power wideband signal.

5. The portable test device of claim 1, wherein said predetermined signal created by said burst noise generator has a specific shaped noise spectral density.

6. The portable test device of claim 1, wherein said filter is a digital bandpass filter.

7. The portable test device of claim 1, wherein said power source is a battery.

8. The portable test device of claim 1, wherein said power source is an AC line source.

9. A method adapted for determining passive intermodulation in a radio frequency communication system, comprising the steps of:
providing a power source;
generating a wideband signal over a predetermined time span of between about 100 microseconds and 100 milliseconds;
distorting said wideband signal to create a wideband signal having a first signature;
transmitting said wideband signal with said first signature through at least a part of the radio frequency communication system;
receiving a wideband signal from at least a part of the radio frequency communications system which has a second signature; and
correlating said first signature with said second signature to determine the amount of passive intermodulation present in the radio frequency communication system.

10. The method of claim 9, wherein said high power wideband signal is a burst noise having a specific shaped noise spectral density.

11. The method of claim 9, further comprising the step of filtering said wideband signal with said second signature to reduce distortion prior to correlating said second signature with said first signature.

12. The method of claim 9, wherein said wideband signal with said first signature is digitized prior to correlating said wideband signal with said second signature.

13. The method of claim 9, further comprising the step of filtering said wideband signal with said first signature to reduce distortion in said wideband signal prior to transmitting said wideband signal through the test apparatus.

14. The method of claim 9, further comprising the step of providing a visual display apparatus for viewing the relative levels of passive intermodulation present in the radio frequency communication system.

15. A method for detecting radio frequency intermodulation interference in a device under test, comprising:
generating a burst noise signal;
sampling said burst noise signal;
providing said burst noise signal to said device under test;
receiving a signal from said device under test in response to said burst noise signal;
sampling said signal received from said device under test; and
correlating said sampled burst noise signal and said sampled signal received from said device under test to determine whether said device under test is a source of intermodulation interference.

16. The method of claim 15, further comprising generating a score indicative of a likelihood that said device under test is a source of intermodulation interference.

17. The method of claim 15, wherein correlating said sampled burst noise signal and said sampled signal received from said radio frequency apparatus comprises:
creating a hypothetical interference signature; and
comparing said hypothetical interference signature to said sampled signal received from said radio frequency apparatus in response to said burst noise signal.

18. The method of claim 15, wherein said burst noise signal has a duration of less than 1 second.

19. The method of claim 15, wherein said burst noise signal has a shaped noise spectral density.

20. The method of claim 15, wherein said step of providing said sampled burst noise signal comprises passing said sampled burst noise signal through a duplexer.

21. The method of claim 20, wherein said step of receiving a signal from said device under test in response to said burst noise signal comprises passing said received signal through said diplexer.

22. An apparatus for detecting intermodulation interference, comprising:
a burst noise generator for generating a first signal;
a signal sampler;
a diplexer;
a coupler; and
a processor, wherein a digital representation of said first signal is correlated to a digital representation of a second signal passed from said duplexer to said processor.

23. The apparatus of claim 22, wherein said first signal comprises a plurality of frequencies.

24. The apparatus of claim 22, wherein said first signal is time and frequency limited.

25. The apparatus of claim 22, further comprising an amplifier for altering an amplitude of said first signal.

26. The apparatus of claim 22, wherein said processor comprises a field programmable gate array.

27. The apparatus of claim 22, wherein said coupler comprises a coaxial connector.

28. The apparatus of claim 22, wherein said signal sampler comprises an analog to digital converter.
